(19) United States
(12) Patent Application Publication
(10) Pub. No.: US 2012/0169739 A1
(43) Pub. Date: Jul. 5, 2012

(54) 360° MULTIDIMENSIONAL ANALYTICAL VISUALIZATIONS

(76) Inventor: THOMAS MEDER, Eggenstein-Leopoldshafen (DE)

(21) Appl. No.: 12/980,409

(22) Filed: Dec. 29, 2010

(51) Int. Cl. G06T 11/20

(52) U.S. Cl. 345/440

(57) ABSTRACT

Various embodiments of systems and methods for 360° multidimensional analytical visualizations are described herein. A 360° graphical representation of several dimensions at one time, arranged around a circle, oval, or rectangle is described. To get deeper insights, a user can select a certain entity of a dimension by clicking on it. This causes filtering on transactions or facts where this entity is involved. Initially, all entities of a dimension corresponded to 100% share of the dimension, after clicking on the dimension the view is reduced to this entity's portion. The rest of the dimensions react similarly by reducing their view also to this focus.

### FIELD

The field generally relates to the software arts, and, more specifically, to methods and systems for 360° multidimensional analytical visualizations.

### BACKGROUND

Visualization can be an image, a diagram, an animation, or any other visual element that communicates a message. Visual analysis focuses on human interaction with visualization systems as part of a larger process of data analysis. Visual analytics is a multidisciplinary field that includes the following areas: analytical techniques that enable users to obtain deep insights that directly support assessment, planning, and decision making; data representations and transformations that convert all types of conflicting and dynamic data in ways that support visualization and analysis; techniques to support production, presentation, and dissemination of the results of an analysis to communicate information in the appropriate context to a variety of audiences; and so on. The main challenge in the area of business analytics is to find a representation of multidimensional data. Most approaches, like bar charts, find two-dimensional representations (setting two dimensions into relation) while hiding all other dimensions. For example, a sales manager may want to get a deeper insight into the revenue figures of a company. The sales manager may want to analyze the following dimensions: customer, product, product group, sales region, sales team, and so on. To analyze this data, the sales manager might use long data tables at different aggregation levels (subtotals and averages). An example for a graphical representation is a bar chart, but this is restricted to display one dimension at once (e.g., revenue per sales region—one bar representing one sales region).

### SUMMARY

Various embodiments of systems and methods for 360° multidimensional analytical visualizations are described herein. In an embodiment, the method includes receiving a selection of a key figure from a navigation pane, wherein the key figure is related to a set of dimensions, each dimension including one or more entities. The selected key figure is added to a detail pane, wherein the detail pane is part of a graphical representation. The method further includes receiving a selection of an entity of a dimension from the set of dimensions at a dimension pane as part of the graphical representation and filtering the set of dimensions and by the selected entity. Finally, the graphical representation is adapted to display the set of dimensions at one time representing information related to the selected entity, the information including a portion of the key figure for the one of more entities for each dimension.

In an embodiment, the system includes a processor and a memory in communication with the processor. The memory includes a graphical representation to display a set of dimensions at one time representing information related to a selected entity of a dimension, the information including a portion of a key figure related to one or more entities of the set of dimensions. The memory also includes a dimension pane that includes the set of dimensions equally distributed in the graphical representation, each dimension including at least one entity. A detail pane is included that contains one or more key figures and a navigation pane is included that lists available dimensions and key figures for selection to the graphical representation.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an exemplary 360° graphical representation of several dimensions at one time according to various embodiments.

FIG. 2 is a block diagram illustrating elements of the graphical representation according to various embodiments.

FIG. 3 is a flow diagram illustrating a method for arrangement of entities and analyzing a statistical finding in a 360° graphical representation according to various embodiments.

FIG. 4 is a block diagram illustrating an exemplary initial state of the 360° graphical representation according to various embodiments.

FIG. 5 is a block diagram illustrating a selection of dimension as a first user interaction with the 360° graphical representation in an exemplary scenario according to various embodiments.

FIG. 6 is a block diagram illustrating a selection of a second dimension as a second user interaction with the 360° graphical representation in the exemplary scenario according to various embodiments.

FIG. 7 is a block diagram illustrating a selection of an entity of a dimension in the 360° graphical representation according to various embodiments.

FIG. 8 is a block diagram illustrating an exemplary computer system 800.

### DETAILED DESCRIPTION

Embodiments of techniques for 360° multidimensional analytical visualizations are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

In various embodiments, a 360° graphical representation of several dimensions at one time, arranged around a circle, oval, or rectangle is presented. The different dimensions are placed around the shape, called “dimension pane”. Each dimension shares the same portion of degrees in the outer part of the dimension pane (e.g., four dimensions—each dimension allocates 90° of the dimension pane). The inner part of the dimension pane is designated for displaying key figures, called “detail pane”.

To get deeper insights, a user can select a certain entity of a dimension by clicking on it. This causes filtering on transactions or facts where this entity is involved. Initially, all entities of a dimension corresponded to 100% share of the dimension, after clicking on the entity the view is reduced to this entity's portion. The rest of the dimensions react similarly by reducing their view also to this focus.

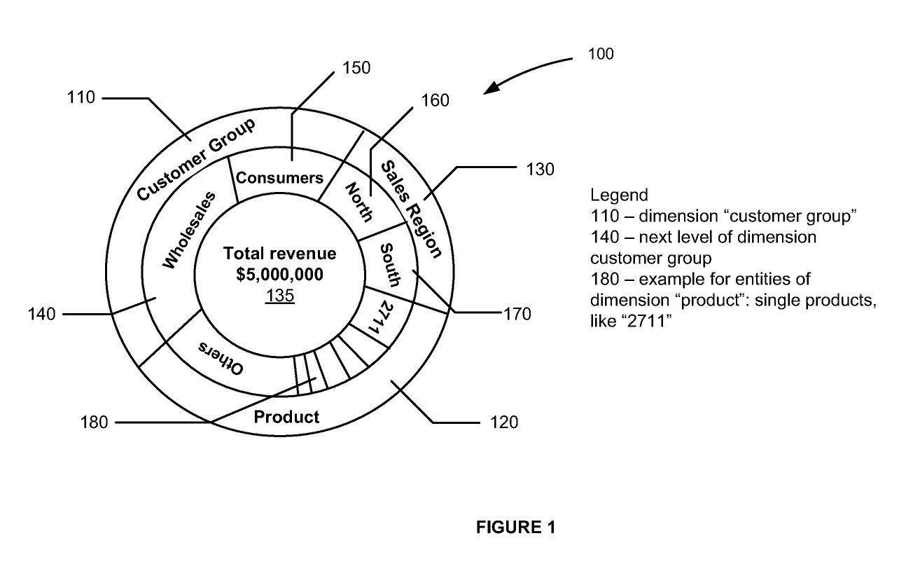

FIG. 1 is a block diagram illustrating an exemplary 360° graphical representation of several dimensions at one time according to various embodiments. Graph 100 is a 360° graphical representation of several dimensions at one time. In an exemplary business scenario, a sales department of sporting equipment generated revenue of $5,000,000 for the current year. The sales manager wants to determine what part of the revenue he or she has generated. The sales manager enters the following dimensions in the dimension pane: customer groups 110, products 120, and sales region 130. Each of these dimensions represents the total revenue of $5,000,000 135 and allocates equal portion of the dimension pane. The dimensions are split into one or more entities. Customer groups 110 dimension includes wholesales 140 (with total $4 million revenue) entity and consumers 150 (with total $1 million revenue) entity as a next level of the dimension. The wholesales 140 entity allocates ⅘ of the space for customer groups 110, while consumers 150 entity allocates ⅕ of the space according to their contribution.

Similarly, products 120 dimension includes the following entities as sub-dimensions: 2711, and others 180, each of them allocating different portion of the products 120 dimension space according to their own contribution. Sales region 130 dimension includes north 160 (e.g., North America) and south 170 (e.g., South America) entities. Analogously, north 160 and south 170 entities allocate space according to their own contribution. Individually, each dimension represents the total revenue ($5 million). If a user selects the consumers 150 entity, the representation will change. A filter on the consumers 150 entity is applied and all three dimensions will show entities that are related to some business with this customer group. The inner part of the dimension pane, the detail pane, will show revenue of $1 million, e.g., “consumer revenue: $1,000,000”. All dimensions will represent the revenue of $1 million and will display entities according to their contribution in regard to this customer group.

Graph 100 is a visual representation of statistical data for the output on paper, mobile devices, computer screens, and so on. It is assumed that quantitative data items are contextual, i.e., linked with some circumstances (e.g., the temperature curve over a day is represented by several measurements at different points in time at a given location). In various embodiments, the data items are analyzed by observing the different circumstances at one time. The 360° graphical representation is able to set several dimensions into correlation.

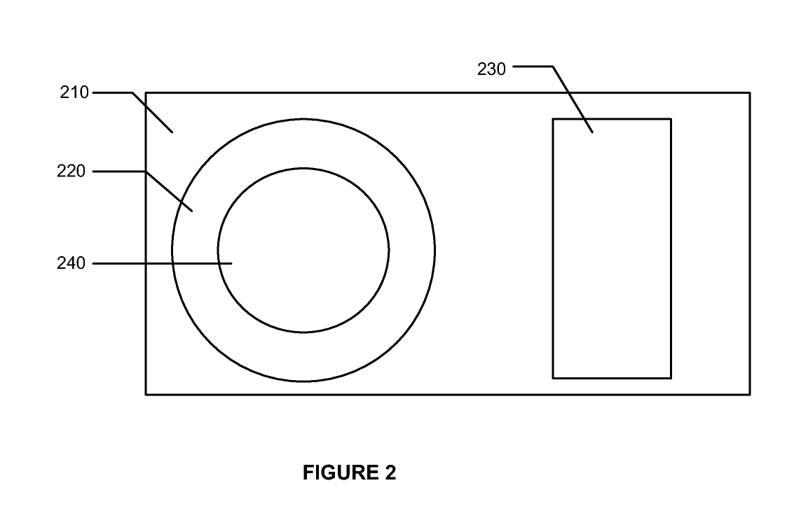

FIG. 2 is a block diagram illustrating elements of the graphical representation according to various embodiments. In various embodiments, the 360° graphical representation is bound to an interactive computer software application. The 360° graphical representation includes the following elements: graph 210, dimension pane 220, navigation pane 230, and detail pane 240. The dimension pane 220 includes the elements: dimensions (e.g., dimensions 110, 120, and 130), key figure dimensions, and entities (e.g., north 160 and south 170). The graph 210 represents the 360° graphical representation. The outer part of the representation is the dimension pane 220. A dimension displays its description in the outer part of the dimension pane 220 and its entities in the inner part of the dimension pane 220. The inner part of the representation is the detail pane 240. The dimensions are a group of entities of the same entity type. The available dimensions are shown on the navigation pane 230. Some of them may be displayed in the graph 210 and some of them may not. In addition, the navigation pane 230 shows selections that have been made to the dimensions by drill-downs. Detail pane 240 is the inner part of the graph and contains one or more key figures. In addition, tables or other useful data can be displayed in the detail pane 240.

An entity is an object from the real world, for example, a person, a company, a product, a department, and so on. Several entities of the same entity type form a dimension. An entity is displayed in the dimension pane 220. The entities shown in the dimension pane 220 are sorted in descending order according to their contribution to the master key figure. In various embodiments, entities with a contribution above a relevance factor are highlighted in the dimension pane 220. Entities with no contribution are not shown and entities with small contribution are grouped in a new entity with a title “others” or a similar description. The relevance factor is defaulted but can be changed by the user. If a key figure's contribution is above this threshold, it may be marked as significant with a special color, e.g., highlighted in red.

Key figures may reflect actions (e.g., a single purchase) or states (e.g., temperature) of the entities by statistical aggregations. These key figures might be, for example, totals or averages. A key figure is often multidimensional, this is, related to several dimensions and their entities. Key figures can be analyzed at their highest level (e.g., revenue of a company), levels in between (e.g., revenue of a given sales region—north 160), or at the level of a single event or state (e.g., revenue per a given customer). The detail pane 240 may contain several key figures, but the allocation of space between the entities by their contribution must be related to a single key figure. This key figure can be selected as a master key figure.

A key figure dimension is a key figure that has been included in the dimension pane 220. The key figure dimension has a scale in percentage, amounts, or other key figure units. The user can use this scale to narrow down the results that are represented at the graph 210. If a user sets a filter at a certain scale value, the graph 210 gets a second filter that displays the largest transactions or states that are representing this portion of the key figure. For example, the user drags the key figure “revenue” from the navigation pane 230 to the dimension pane 220. The user sets the scale at 80%. A filter is applied that shows the entities of the sales that contributed most to 80% of the revenue.

In various embodiments, a hierarchical dimension has entities that are aggregation of the entities themselves. The hierarchical dimension has several (sometimes virtual) levels down to entities of the real world. For example, the sales region (which is a hierarchical dimension) has entities “south” and “north” as level one. The “north” entity is split into “north-west” and “north-east” entities as level two. The “north-west” entity is split into federal states, e.g., Maine, New Hampshire, Vermont, and so on as level three. This hierarchy can be continued down to communities of the store, where the sales transaction took place. The highest level of a hierarchical dimension is displayed at the outer border of the dimension pane 220. The deepest level of the hierarchy, its entities, is displayed at the inner border of the dimension pane 220. The initial view for a hierarchical dimension might be restricted to two levels, e.g., the two upper levels. The user interaction may add the deeper levels if needed.

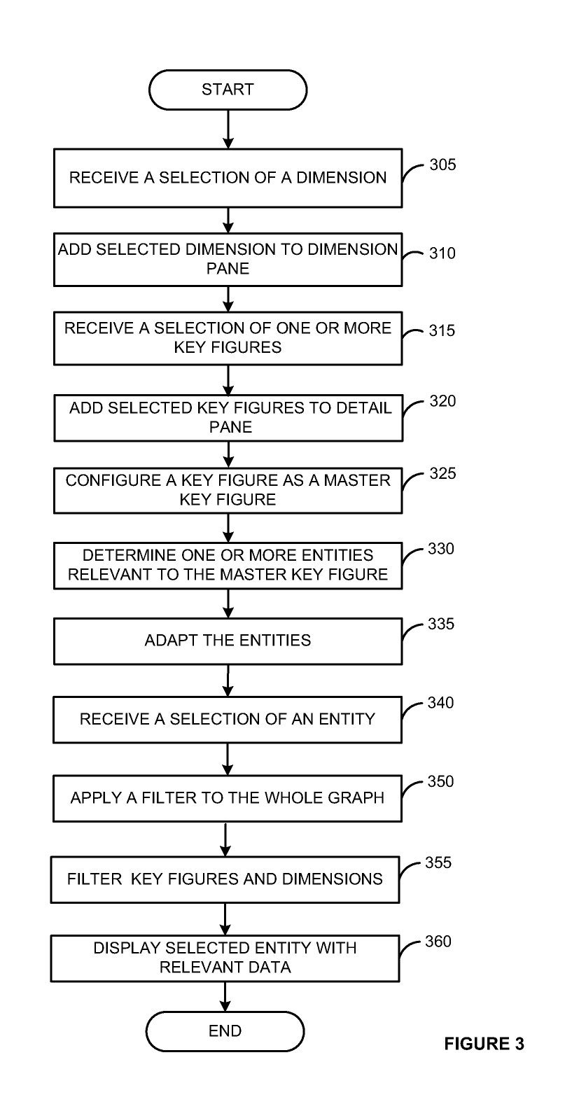

FIG. 3 is a flow diagram illustrating a method for arrangement of entities and analyzing a statistical finding in a 360° graphical representation according to various embodiments. In various embodiments, when the graph 210 is opened, it shows a default selection of dimensions that are already at the dimension pane 220. Further, the navigation pane 230 displays the list of available dimensions. At block 305, a selection of a dimension from the navigation pane 230 is received. The user selects a given dimension that wants to analyze and via some functionality such as drag and drop places the selected dimension at the dimension pane 220. At block 310, the selected dimension is added to the dimension pane 220 of the graph 210. The area of the dimension pane is now divided into equal parts to give every dimension the same portion of space, including the newly added dimension. The user can also remove dimensions from the dimension pane 220. The user selects a given dimension in the dimension pane 220 and removes it out of the graph 210 by some common functions such as drag it out of the graph, pressing the Delete button on the keyboard, and so on. This action causes the dimension to disappear from the dimension pane 220. Automatically, the space formally allocated by the removed dimension is distributed in equal parts among the remaining dimensions.

In some embodiments, the user may want to add a key figure from the navigation pane 230 or from the detail pane 240 to the dimension pane 220 as a dimension. The available key figures are listed in the navigation pane 230. A default key figure is already displayed at the detail pane 240, when the graph is opened the first time. The user selects the key figure from the navigation pane 230 and drags it to the dimension pane 220. The key figure is converted into a key figure dimension before it is added to the dimension pane 220. Similarly, the dimension pane is now divided into equal parts to give every dimension the same portion of space, including the key figure dimension. A key figure dimension can be removed out of the graph 210 by some common functions such as drag it out of the graph, pressing the Delete button on the keyboard, and so on. The graph reacts analogously to when removing a dimension from the dimension pane 220.

In other embodiments, the user may want to add a key figure from the navigation pane 230 to the detail pane 240. At block 315, a selection of one or more key figures from the navigation pane 230 is received. At block 320, the selected key figures are added to the detail pane 240 replacing the default key figure. If a key figure dimension has been selected in the dimension pane 220 and dragged to the detail pane, it is converted into a key figure and added to the detail pane 240. A key figure drawn to the dimension pane 220 is placed as a key figure dimension, but a key figure drawn to the detail pane 240 is placed as a key figure. A key figure can be removed from the detail pane 240 by some common functions such as drag it out of the graph, pressing the Delete button on the keyboard, and so on. If no key figure remains in the detail pane 240, the default key figure is automatically added and displayed in the detail pane 240. At block 325, a key figure from the navigation pane 230 is configured as a master key figure by receiving a selection of this key figure (e.g., the selection can be performed via a double-click from the user). In response to setting the master key figure, it is determined which entities have contribution to this master key figure, at block 330. At block 335, the arrangement of entities is adapted. The space of a dimension is distributed to relevant entities by their contribution. Entities with contribution above the relevance factor are highlighted. Entities with small contribution are replaced by a common entity, e.g., titled “others”. Entities with no contribution are hidden. The master key figure is highlighted.

At block 340, a selection of an entity in the dimension pane 220 is received. The entity may be selected by clicking on it in the user interface. At block 350, a filter is applied to the whole graph 210 in response to the received selection. At block 355, all key figures and dimensions are filtered by the selected entity. At block 360, the selected entity is displayed and fills the whole (100%) width of the area of its dimension—as it represents 100% contribution to the master key figure. Additionally, the filter value is displayed in the navigation pane 230. The selection of an entity is applied in addition to any previous selections to the entity. Selections can be undone by a specific navigation button or deletion of the filter in the navigation pane 230.

In some embodiments, the selection of an entity can be performed at a hierarchical dimension. The behavior of filtering is the same as for the selection of an entity of an ordinary dimension. The display at the hierarchical dimension pane changes as follows: the selected entity of the hierarchy gets highlighted and expanded to 100% of the width of the dimension. The next lower level is displayed at the inner boarder of the dimension displaying rest of the entities in the hierarchy. The highest level of the hierarchy, which is displayed on the outer part of the dimension pane 220, disappears.

The drill-down by an entity is performed to analyze the statistical finding down to its root elements. This is done by applying filters and sorting the key figures and dimensions. In an exemplary scenario, a sales manager finds out that he or she does 80% of the sales revenue with wholesalers. The sales manager wants to know which customers are behind. Therefore, he or she filters the sales transactions by dimension customer group=“wholesales”. The composition of this customer group is displayed.

In other embodiments, a drill-down by most contributing entities can be performed. A dimension, hierarchical or ordinary, displays a scale representing 100% of the dimensions contribution. The user can select a point in this scale that symbolizes a certain contribution to the key figure. The dimension is reduces to the largest entities that correspond to this contribution. Other dimensions are reduced to entities that are bound to underlying transactions or states. For example, a sales manager assumes that the most of his or her business is done with a small number of customers. Therefore, the sales manager sets the scale of the customer dimension to 80%. As the customer scale is reduced to five customer entities, his or her assumption gets confirmed. Additionally, the sales manager learns that only ten products are involved in transactions with these most important customers (as all other products vanish from the “products” dimension accordingly).

In some embodiments, a drill-down by a key figure for key figure dimensions can be performed. At this dimension type, a scale allows users to select a certain portion of a key figure. The graph 210 displays then the most contributing entities at each dimension. A prerequisite is having a key figure placed in the dimension pane to create a key figure dimension. The scale appears and allows selecting a percentage or portion of the key figure.

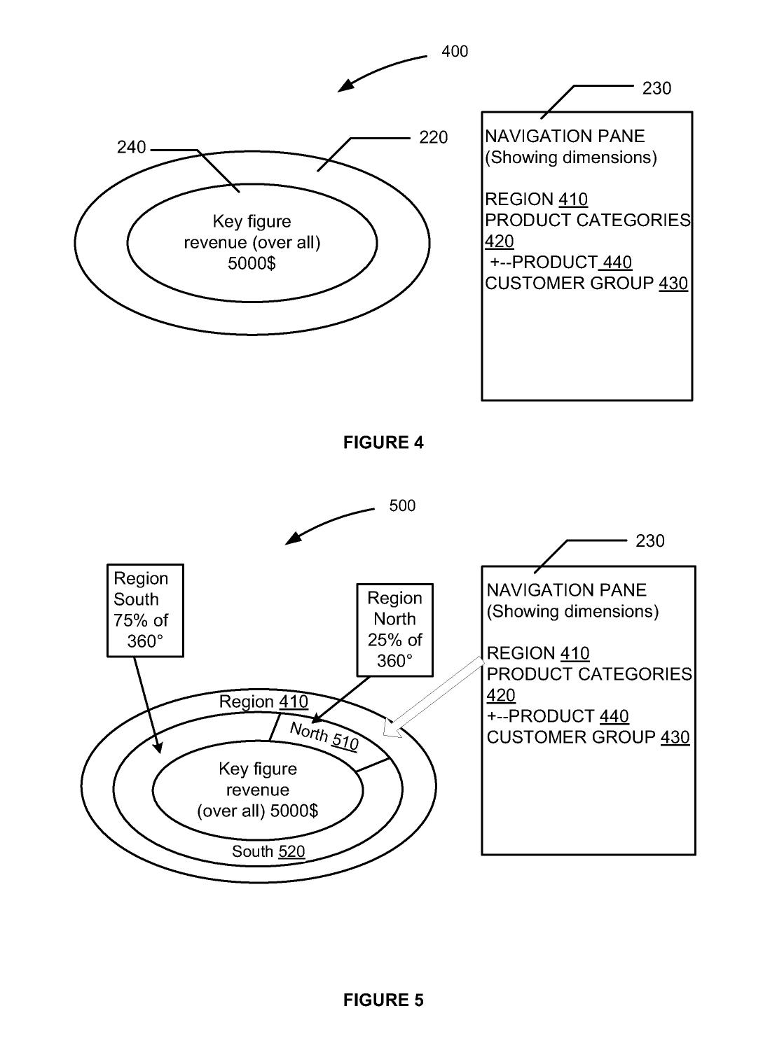

FIG. 4 is a block diagram illustrating an exemplary initial state of the 360° graphical representation according to various embodiments. Representation 400 shows the initial state of the 360° graphical representation of statistical data. Representation 400 includes dimension pane 220 as outer part and detail pane 240 as inner part. By default, a key figure is added in the detail pane 240. The key figure displays total revenue of $5000. Navigation pane 230 is also included. Navigation pane 230 lists a set of dimensions such as: region 410, product categories 420, and customer group 430. Each of these dimensions may include a set of entities as a next level in a hierarchical dimension (e.g., product 440 as an entity of product categories 420).

FIG. 5 is a block diagram illustrating a selection of dimension as a first user interaction with the 360° graphical representation in an exemplary scenario according to various embodiments. Representation 500 shows a first user interaction with the 360° graphical representation. The user selects region 410 as a dimension from the navigation pane 230 to see the distribution of the total revenue per different regions. The user drags the region 410 dimension out of the navigation pane 230 and drops it at the dimension pane 220. After moving the region 410 dimension, it disappears from the navigation pane 230. In the exemplary scenario, region 410 has two entities: north 510 and south 520. Region north 510 has earned 25% of the total revenue, while region south 520 possesses 75%. Accordingly, after placing the region 410 dimension at the dimension pane 220, region 410 fills 100% of the graph representation 400 as it is the only dimension at this stage. Region 410 allocates the outer part of the dimension pane 220 and the two entities, north 510 and south 520, allocate the inner part of the dimension pane 220. According to the revenue distribution per the different regions, region north 510 allocates 25% of the 360° graphical representation and region south 520 allocates 75% of the 360° graphical representation. The key figure remains the same pointing to $5000 revenue total.

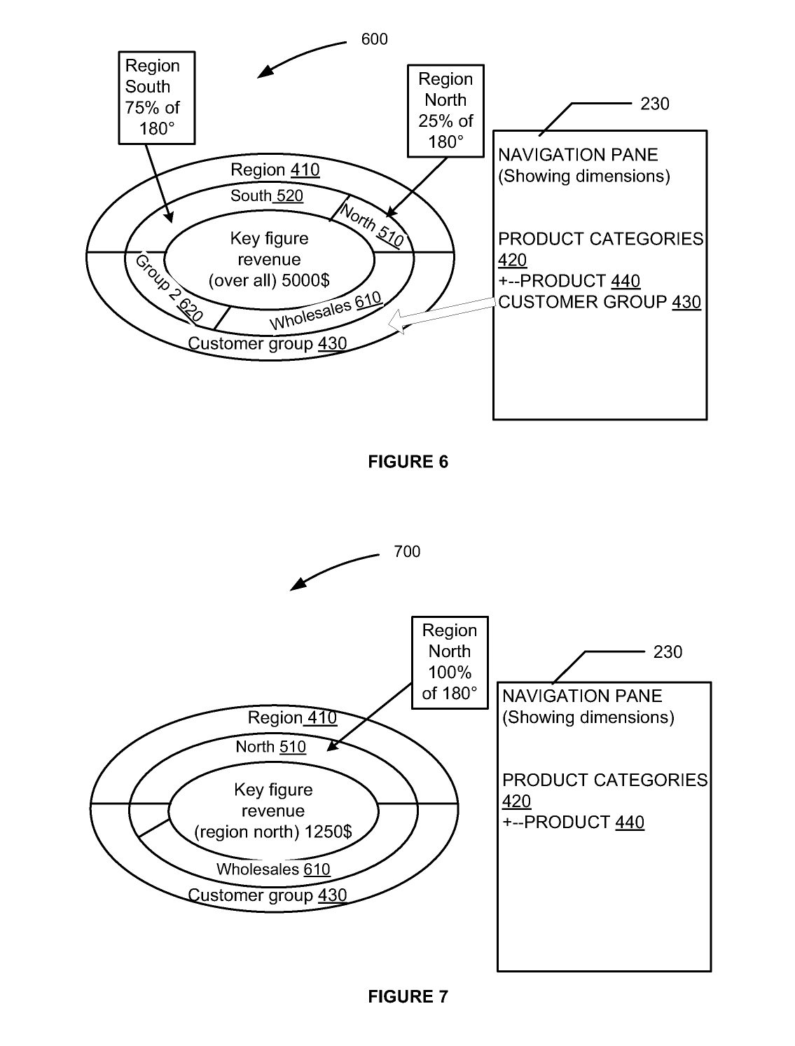

FIG. 6 is a block diagram illustrating a selection of a second dimension as a second user interaction with the 360° graphical representation in the exemplary scenario according to various embodiments. Representation 600 shows a second user interaction with the 360° graphical representation. After the user has arranged region 410 dimension in the 360° graphical representation, the user may want to insert more dimensions. Therefore, the user selects customer group 430 dimension and drags it to the dimension pane 220. After moving the customer group 430 dimension, it disappears from the navigation pane 230. In the exemplary scenario, customer group 430 has two entities: wholesales 610 and group 2 620 allocating the inner part of customer group 430 dimension, each sharing some portion of the space according to their distribution. Placing the customer group 430 dimension on the dimension pane 220 causes the dimension pane 220 to split its space in two equal parts, so that each dimension shares 50% of the whole space, i.e. 180°. Accordingly, the entities in both dimensions are adapted. Region north 510 allocates 25% of the 180° graphical representation and region south 520 allocates 75% of the 180° graphical representation. The key figure remains the same pointing to $5000 revenue total.

FIG. 7 is a block diagram illustrating a selection of an entity of a dimension in the 360° graphical representation according to various embodiments. Representation 700 shows selection of an entity of a dimension in the 360° graphical representation. In the exemplary scenario, the user selects the entity north 510 of dimension region 410 (i.e., drills down the graph by entity). Accordingly, the 360° graphical representation is adapted by the user selection. As entity north 510 is selected, only this entity is displayed in the region 410 dimension allocating the whole dimension space. In this case allocating 100% of the dimension space and 50% of the 360° graphical representation. Representation 700 shows only details for north 510 entity. The entities of the other dimension, customer group 430, are adapted according to the selection, reflecting their contribution to the revenue of north 510. The key figure is changed pointing to the revenue of the north 510 entity. As defined, north 510 entity possesses 25% of the total revenue of $5000, the revenue of north 510 entity is equal to $1250. Region south 520 and its allocation are hidden.

In various embodiments, the 360° graphical representation provides decision relevant information for enterprise systems. The 360° graphical representation can be used in dashboards, applications, mobile devices with screens, computers with screens, and so on. The graph is able to display several dimensions at one time and to represent its entities' portion of a key figure compared to the whole quantity.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

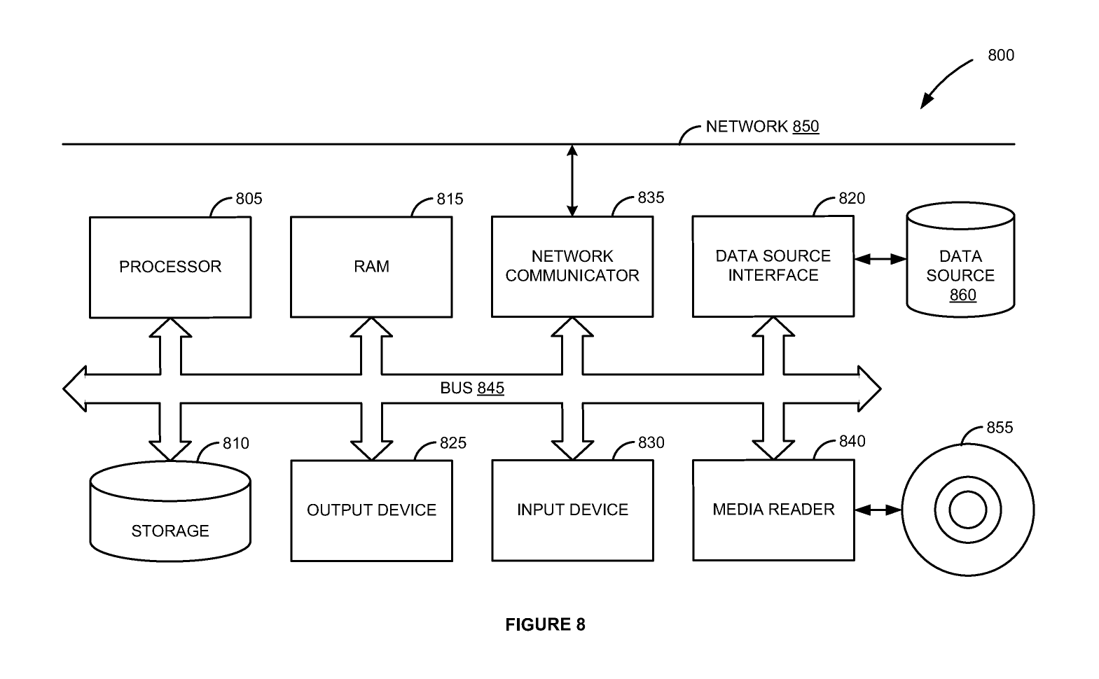

FIG. 8 is a block diagram illustrating an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be access via one or more abstraction layers implemented in hardware or software. For example, the data source 860 may be access by network 850. In some embodiments the data source 860 may be accessed via an abstraction layer, such as, a semantic layer.

A data source 860 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
receive a selection of a key figure from a navigation pane, wherein the key figure is related to a set of dimensions, each dimension including at least one entity;
add the selected key figure to a detail pane, wherein the detail pane is part of a graphical representation;
receive a selection of an entity of a dimension from the set of dimensions at a dimension pane as part of the graphical representation;
filter the set of dimensions by the selected entity; and
change the graphical representation to display the set of dimensions at one time representing information related to the selected entity, the information including a portion of the key figure for the at least one entity for each dimension.

2. The article of manufacture of claim 1, further comprising instructions to cause the computer to:
configure the key figure as a master key figure; and
distribute dimension space according to the at least one entity for each dimension related to the master key figure by contribution of the at least one entity.

3. The article of manufacture of claim 2, further comprising instructions to cause the computer to:
highlight a second entity from the set of dimensions if its contribution to the master key figure is above a relevance factor;
hide the second entity in the graphical representation if it has no contribution to the master key figure; and
add the second entity in a separate group if its contribution to the master key figure is below the relevance factor.

4. The article of manufacture of claim 1, further comprising instructions to cause the computer to:
if the selected entity is included in a hierarchical dimension, display the entity in the hierarchical dimension as a first level of a hierarchy; and
display a next lower level of entities in the hierarchical dimension.

5. The article of manufacture of claim 1, wherein the dimension includes a scale representing contribution of the set of dimensions.

6. The article of manufacture of claim 5, further comprising instructions to cause the computer to:
receive a selection of a point in the scale, wherein the point symbolizes contribution to the key figure;
reduce the dimension to display largest entities that correspond to the contribution; and
reduce rest of the set of dimensions to display entities that are bound to underlying transactions.

7. The article of manufacture of claim 2, wherein the at least one entity is sorted in descending order according to its contribution to the master key figure.

8. A computerized method comprising:
receiving a selection of a key figure from a navigation pane, wherein the key figure is related to a set of dimensions, each dimension including at least one entity;
adding the selected key figure to a detail pane, wherein the detail pane is part of a graphical representation;
receiving a selection of an entity of a dimension from the set of dimensions at a dimension pane as part of the graphical representation;
filtering the set of dimensions by the selected entity; and
adapting the graphical representation to display the set of dimensions at one time representing information related to the selected entity, the information including a portion of the key figure for the at least one entity for each dimension.

9. The method of claim 8, further comprising:
configuring the key figure as a master key figure; and
distributing dimension space according to the at least one entity for each dimension related to the master key figure by contribution of the at least one entity.

10. The method of claim 9, further comprising:
highlighting a second entity from the set of dimensions if its contribution to the master key figure is above a relevance factor;
hiding the second entity in the graphical representation if it has no contribution to the master key figure; and
adding the second entity in a separate group if its contribution to the master key figure is below the relevance factor.

11. The method of claim 8, further comprising:
if the selected entity is included in a hierarchical dimension, displaying the entity in the hierarchical dimension as a first level of a hierarchy; and
displaying a next lower level of entities in the hierarchical dimension.

12. The method of claim 8, wherein the dimension includes a scale representing contribution of the set of dimensions.

13. The method of claim 12, further comprising:
receiving a selection of a point in the scale, wherein the point symbolizes contribution to the key figure;
reducing the dimension to display largest entities that correspond to the contribution; and
reducing rest of the set of dimensions to display entities that are bound to underlying transactions.

14. The method of claim 9, wherein the at least one entity is sorted in descending order according to its contribution to the master key figure.

15. A computing system comprising:
a processor; and
a memory in communication with the processor, the memory comprising:
a graphical representation to display a set of dimensions at one time representing information related to a selected entity of a dimension, the information including a portion of a key figure related to a set of entities from the set of dimensions;
a dimension pane that includes the set of dimensions equally distributed in the graphical representation, each dimension including at least one entity;
a detail pane that includes at least one key figure; and
a navigation pane that lists available dimensions and key figures for selection to the graphical representation.

16. The computing system of claim 15, wherein the key figure is a master key figure that is related to allocation of space among the set of entities by their contribution.

17. The computing system of claim 15, further comprising a hierarchical dimension that includes a hierarchy of entities.

18. The computing system of claim 17, wherein a highest level of the hierarchy is displayed as an outer border of the dimension pane and a lowest level in the hierarchy is displayed as an inner border of the dimension pane.

19. The computing system of claim 16, wherein the set of entities is sorted in descending order according to their contribution to the master key figure.

20. The computing system of claim 15, further comprising a key figure dimension that includes a scale of key figure units to narrow results displayed in the graphical representation by selecting a point in the scale.
